(19) United States
(12) Patent Application Publication
(10) Pub. No.: US 2011/0290915 A1
(43) Pub. Date: Dec. 1, 2011

(54) LASER WELDING METHOD, PIPE JOINT PRODUCT, AND INJECTOR USING THE PRODUCT

(75) Inventors: Koichi SUGIYAMA, Nagoya-city (JP); Hisatoshi Tsukahara, Okazaki-city (JP); Shinichirou Nezaki, Nishio-city (JP); Makoto Takeuchi, Obu-city (JP); Mitsuya Suzuki, Kariya-city (JP)

(73) Assignee: DENSO CORPORATION, Kariya-city (JP)

(21) Appl. No.: 13/149,043

(22) Filed: May 31, 2011

(30) Foreign Application Priority Data
May 31, 2010 (JP) 2010-124314

(51) Int. Cl. F02M 63/00; F16L 13/02; B23K 26/00

(52) U.S. Cl. 239/533.2; 219/121.64; 285/288.1

(57) ABSTRACT

In a fitting process, a first pipe made of metal and a second pipe made of metal are fitted together such that an outer wall of the first pipe and an inner wall of the second pipe are opposed to each other. In a preheating process, the pipes are heated such that temperature of a fitting surface converges at a first temperature, which is lower than melting points of the pipes. In a welding process, the second pipe is irradiated with a laser to heat the pipes such that the temperature of the fitting surface converges at a second temperature, which is equal to or higher than the melting points; a vicinity of the fitting surface is melted to produce a weld penetration part; and the pipes are joined together to form a pipe joint product. An output and irradiation time of the laser in the welding process are set, so that the second temperature becomes such a temperature that a leading end of the penetration part is located within thickness of the first pipe.

### CROSS REFERENCE TO RELATED APPLICATION

This application is based on and incorporates herein by reference Japanese Patent Application No. 2010-124314 filed on May 31, 2010.

### BACKGROUND OF THE INVENTION

1. Field of the Invention

The present invention relates to a laser welding method applied to overlap welding of thin-walled metal pipes, a pipe joint product formed by the method, and an injector using the product.

2. Description of Related Art

Conventionally, a laser light having high energy and good directivity is used for precise welding of a metal member, for instance. A laser welding method suitable for welding of a stainless steel pipe or a steel-sheet end face, and a method for limiting generation of a defect such as air bubbles in the laser welding, are disclosed, for example, in JP-A-H08-132262, JP-A-H09-295011, and JP-A-2001-205464.

In an injector that is used for a fuel injection system in, for example, an internal combustion engine for a vehicle, since a fuel passage member is generally formed into a thin-walled pipe shape, it is effective to use laser welding for a precise jointing between the fuel passage member and a fitted part of an injection nozzle, for example. A method for preventing welding distortion, for instance, in the laser welding of the injector is disclosed, for example, in JP-A-H11-270439 and JP-A-2002-317728.

Generally, in the laser welding, an “irradiated side member” is overlapped with a “melted side member”, and the irradiated side member is irradiated with a laser. Accordingly, metal is made to melt from the irradiated side member into the melted side member. By controlling an output value and irradiation time of the laser with which the member is irradiated, depth and width of weld penetration from the irradiated side member into the melted side member are controlled.

When pipes are fitted together and their overlapping portion is welded, an inner pipe corresponds to the “melted side member”, and an outer pipe corresponds to the “irradiated side member”. Metal is melted, spanned a fitting surface between an inner wall of the outer pipe and an outer wall of the inner pipe. In a product for which a high level of quality is required with respect to, for example, surface roughness or foreign matter adhesion of an inner wall of the inner pipe, such as an injector, it is desirable that the weld penetration depth should be adjusted such that reach of a weld penetration part to the inner wail of the inner pipe is avoided and a front end of the weld penetration part is located within thickness of the inner pipe.

However, heat capacity that a member of the thin-walled pipe can be received is small, and temperature of the member at the time of welding is easily influenced by its environmental temperature. Accordingly, temperature of the weld penetration part is not stabilized, and it is difficult to accurately control the penetration depth only through the control of the output value and irradiation time of the laser with which the member is irradiated. If the weld penetration depth is great, a “penetration” defect that the leading end of the weld penetration part passes through the inner wall of the inner pipe may be caused. Moreover, sputters may be produced on the inner wall of the inner pipe due to the “penetration”. As described above, there is a problem that welding quality becomes poor.

### SUMMARY OF THE INVENTION

The present invention addresses at least one of the above disadvantages.

According to the present invention, there is provided a laser welding method. According to the laser welding method, a fitting process is performed. At the time of performing the fitting process, a first pipe made of metal and a second pipe made of metal are fitted together such that an outer wall of the first pipe and an inner wall of the second pipe are opposed to each other. Furthermore, a preheating process is performed. At the time of performing the preheating process, the first pipe and the second pipe are heated such that temperature of a fitting surface between the first pipe and the second pipe converges at a first temperature, which is lower than melting points of the first pipe and the second pipe. In addition, a welding process is performed. At the time of performing the welding process, the second pipe is irradiated with a laser to heat the first pipe and the second pipe such that the temperature of the fitting surface converges at a second temperature, which is equal to or higher than the melting points; a vicinity of the fitting surface is melted to produce a weld penetration part; and the first pipe and the second pipe are joined together to form a pipe joint product. An output and an irradiation time of the laser in the welding process are set, so that the second temperature becomes such a temperature that a leading end of the weld penetration part is located within thickness of the first pipe.

According to the present invention, there is also provided a pipe joint product formed by the laser welding method. An inner wall of the first pipe maintains its pre-welding metallic luster.

According to the present invention, there is further provided an injector adapted for a fuel injection system of an internal combustion engine. The injector includes an injection nozzle, a fuel passage member, a holder, a valve member, and a driving unit. The injection nozzle has a nozzle hole through which fuel is injected. The fuel passage member is joined to the injection nozzle and defines a fuel passage communicating with the nozzle hole. The holder is joined to the fuel passage member on its opposite side from the injection nozzle. The valve member is accommodated inside the fuel passage member to reciprocate therein so as to open or close the nozzle hole. The driving unit is accommodated in the holder and configured to drive the valve member. The fuel passage member and the holder correspond respectively to the first pipe and the second pipe of the pipe joint product.

### BRIEF DESCRIPTION OF THE DRAWINGS

The invention, together with additional objectives, features and advantages thereof, will be best understood from the following description, the appended claims and the accompanying drawings in which:

FIG. 1 is sectional view illustrating an injector in accordance with a first embodiment of the invention;

FIG. 2A is a diagram illustrating a fitting process of a method for laser welding between a fuel passage member and a first cylindrical portion of a holder in the injector in accordance with the first embodiment;

FIG. 2B is a diagram illustrating a preheating process of the method for laser welding between the fuel passage member and the first cylindrical portion in the injector in accordance with the first embodiment;

FIG. 2C is a diagram illustrating a welding process of the method for laser welding between the fuel passage member and the first cylindrical portion in the injector in accordance with the first embodiment;

FIG. 3A is a graph illustrating a change of an output value of a laser light in the preheating process and the welding process of a method for laser welding between the fuel passage member and the holder in the injector in accordance with the first embodiment;

FIG. 3B is a graph illustrating a change of temperature of a fitting surface between the fuel passage member and the holder in the preheating process and the welding process in accordance with the first embodiment;

FIG. 4 is an enlarged sectional view illustrating vicinity of a welded place between the fuel passage member and the holder in the injector in accordance with the first embodiment;

FIG. 5A is a graph illustrating a change of an output value of a laser light in a welding process of a method for laser welding between a fuel passage member and a holder in an injector in accordance with a comparative example;

FIG. 5B is a graph illustrating a change of temperature of a fitting surface between the fuel passage member and the holder in the welding process in accordance with the comparative example;

FIG. 5C is an enlarged sectional view illustrating vicinity of a welded place between the fuel passage member and the holder in the injector in accordance with the comparative example;

FIG. 6A is a graph illustrating a change of an output value of a laser light in a preheating process and a welding process of a method for laser welding between a fuel passage member and a holder in an injector in accordance with a second embodiment of the invention;

FIG. 6B is a graph illustrating a change of temperature of a fitting surface between the fuel passage member and the holder in the preheating process and the welding process in accordance with the second embodiment;

FIG. 7A is a diagram illustrating a fitting process of a method for laser welding between a fuel passage member and a holder in an injector in accordance with a third embodiment of the invention;

FIG. 7B is a diagram illustrating a preheating process of the method for laser welding between the fuel passage member and the holder in the injector in accordance with the third embodiment;

FIG. 7C is a diagram illustrating a welding process of the method for laser welding between the fuel passage member and the holder in the injector in accordance with the third embodiment;

FIG. 8A is a graph illustrating a change of an output value of a laser light in the welding process of the method for laser welding between the fuel passage member and the holder in the injector in accordance with the third embodiment; and

FIG. 8B is a graph illustrating a change of temperature of a fitting surface between the fuel passage member and the holder in the welding process in accordance with the third embodiment.

### DETAILED DESCRIPTION OF THE INVENTION

Embodiments of the invention will be described below with reference to the accompanying drawings. In the embodiments, the same numeral is given to substantially the same component, and the description of the same component is omitted.

### First Embodiment

An injector 10 of a first embodiment of the invention is used for a fuel injection system of an internal combustion engine (not shown), and injects and supplies fuel into the engine.

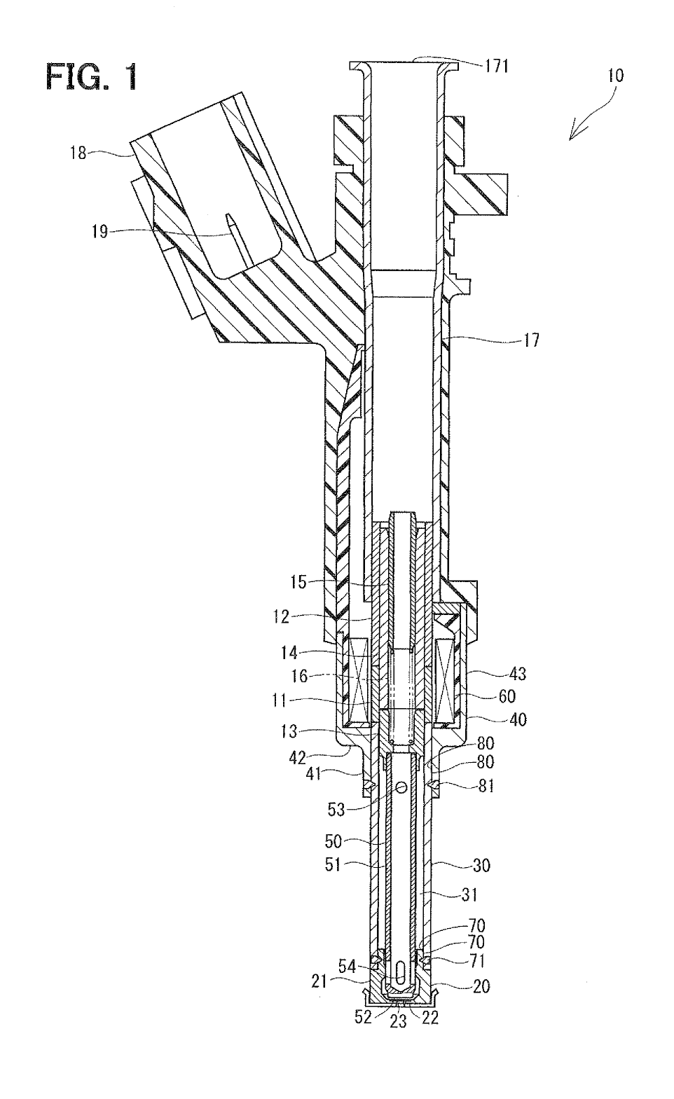

A configuration of the injector 10 will be described in reference to FIG. 1. The injector 10 includes an injection nozzle 20, a fuel passage member 30, a holder 40, a valve member 50, and a coil 60 serving as a driving unit. The injection nozzle 20 is formed from metal and includes a cylindrical portion 21 having a generally cylindrical shape, and a bottom portion 22 covering one end portion of the cylindrical portion 21. In other words, the injection nozzle 20 is formed into a cylindrical shape having a bottom. The bottom portion 22 includes a nozzle hole 23.

The fuel passage member 30 is formed in a generally cylindrical shape from metal. The injection nozzle 20 and the fuel passage member 30 are fitted together such that an outer wall of the cylindrical portion 21 and an inner wall of the fuel passage member 30 are opposed to each other, and these parts are welded together by laser welding. A weld penetration part 71 generated by the laser welding is formed at a fitting surface 70 between the outer wall of the cylindrical portion 21 and the inner wall of the fuel passage member 30. The fitting surface 70 is a surface where the cylindrical portion 21 and the fuel passage member 30 are fitted together, and both an outer wall surface of the cylindrical portion 21 and an inner wall surface of the fuel passage member 30 are referred to as the fitting surface 70. The weld penetration part 71 is formed in a generally annular shape along the whole circumference of the fitting surface 70. Accordingly, a clearance between the outer wall of the cylindrical portion 21 and the inner wall of the fuel passage member 30 is held liquid-tight. A front end of the weld penetration part 71 is located within a thickness of the cylindrical portion 21 on a cross section along a central axis of the cylindrical portion 21 and the fuel passage member 30.

A cylindrical member 11, which is made of a non-magnetic material, is connected to an end portion of the fuel passage member 30 on its opposite side from the injection nozzle 20. Furthermore, a cylindrical member 12 is connected to an end portion of the cylindrical member 11 on its opposite side from the fuel passage member 30. Inner diameters of the cylindrical members 11, 12 are set equally with an inner diameter of the fuel passage member 30.

The holder 40 is formed from metal, and includes a first cylindrical portion 41 having a generally cylindrical shape; a connecting portion 42 extending radially outward from one end portion of the first cylindrical portion 41 and having a generally annular shape; and a second cylindrical portion 43 extending from an outer edge part of the connecting portion 42 in a generally cylindrical shape. The fuel passage member 30 and the holder 40 are fitted together such that an outer wall of the fuel passage member 30 and an inner wall of the first cylindrical portion 41 are opposed to each other, and these parts are welded together by laser welding. A weld penetration part 81 generated by laser welding is formed at a fitting surface 80 between the outer wall of the fuel passage member 30 and the inner wall of the first cylindrical portion 41. The fitting surface 80 is a surface where the fuel passage member 30 and the first cylindrical portion 41 are fitted together, and both an outer wall surface of the fuel passage member 30 and an inner wall surface of the first cylindrical portion 41 are referred to as the fitting surface 80. The weld penetration part 81 is formed in a generally annular shape along the whole circumference of the fitting surface 80. Accordingly, a clearance between the outer wall of the fuel passage member 30 and the inner wall of the first cylindrical portion 41 is held liquid-tight. A front end of the weld penetration part 81 is located within a thickness of the fuel passage member 30 on a cross section along a central axis of the fuel passage member 30 and the first cylindrical portion 41. The laser welding between the injection nozzle 20 and the fuel passage member 30, and the laser welding between the fuel passage member 30 and the holder 40 are described in greater detail hereinafter.

The valve member 50 is formed from metal and includes a cylindrical portion 51 having a generally cylindrical shape, and a bottom portion 52 covering one end portion of the cylindrical portion 51. In other words, the valve member 50 is formed into a cylindrical shape having a bottom. The valve member 50 is accommodated inside the fuel passage member 30 so as to be reciprocated in the member 30. The valve member 50 can open or close the nozzle hole 23 as a result of separation of its bottom portion 52 from the bottom portion 22 of the injection nozzle 20 or contact of its bottom portion 52 with the bottom portion 22. A hole 53 and a hole 54, which communicate between an inner wall and an outer wall of the cylindrical portion 51, are formed on the cylindrical portion 51.

A movable core 13 is press-fitted to the valve member 50 on its opposite side from the bottom portion 52. The movable core 13 is formed from metal, and disposed to be located radially inward of a joint portion of the fuel passage member 30 and the cylindrical member 11. An outer diameter of the movable core 13 is set to be slightly smaller than inner diameters of the fuel passage member 30 and the cylindrical member 11. Accordingly, the movable core 13 can be reciprocated smoothly inside the fuel passage member 30 and the cylindrical member 11 together with the valve member 50.

A fixed core 14 is press-fitted radially inward of the cylindrical members 11, 12. The fixed core 14 is formed cylindrically from metal. The fixed core 14 can be in contact with the movable core 13 to limit displacement of the movable core 13 in the opposite direction from the injection nozzle 20. Therefore, the movable core 13 and the valve member 50 can be reciprocated between the fixed core 14 and the bottom portion 22 of the injection nozzle 20.

A cylindrical adjusting pipe 15 is press-fitted radially inward of the fixed core 14. An urging member 16 is provided between the adjusting pipe 15 and the movable core 13. The urging member 16 has force extending in the axial direction. Thus, the valve member 50 is urged toward the bottom portion 22 of the injection nozzle 20 together with the movable core 13.

The coil 60 having a generally cylindrical shape is accommodated radially inward of the second cylindrical portion 43 of the holder 40, and disposed to be located radially outward of the cylindrical members 11, 12. The coil 60 generates magnetic force upon supply of electricity. As a result, the movable core 13 is attracted to the fixed core 14. Meanwhile, the bottom portion 52 of the valve member 50 is disengaged from the bottom portion 22 of the injection nozzle 20, and the nozzle hole 23 is thereby left open.

A fuel introduction pipe 17 having a generally cylindrical shape is press-fitted on the cylindrical member 12 on its opposite side from the cylindrical member 11. A radially outward part of the fuel introduction pipe 17 is molded using resin. A connector 18 is formed at this molded portion of the pipe 17. A terminal 19 for supplying electricity to the coil 60 is insert-molded in the connector 18.

Fuel, which has flowed into the injector 10 through a feed port 171 of the fuel introduction pipe 17, flows through the inside of the fuel introduction pipe 17, the adjusting pipe 15, the fixed core 14, the cylindrical member 11, the movable core 13, the valve member 50, and the holes 53, 54; and inward of the fuel passage member 30 and inward of the cylindrical portion 21 of the injection nozzle 20. Finally, the fuel is guided into the nozzle hole 23. In this manner, the fuel passage member 30 defines a fuel passage 31, through which fuel flows, radially inward of the member 30.

An operation of the injector 10 will be described. Upon energization of the coil 60, the movable core 13 is attracted to the fixed core 14. Accordingly, the valve member 50 is displaced toward the fixed core 14 integrally with the movable core 13 so as to disengage from the bottom portion 22 of the injection nozzle 20. Consequently, the nozzle hole 23 is put into an opened state (valve-opening state).

The fuel, which has flowed into the injector 10 from the feed port 171 of the fuel introduction pipe 17, flows radially inward of the fuel introduction pipe 17, the adjusting pipe 15, the fixed core 14, the cylindrical member 11, the movable core 13, and the valve member 50; through the holes 53, 54; radially inward of the fuel passage member 30; and inward of the cylindrical portion 21 of the injection nozzle 20. Finally, this fuel is injected through the nozzle hole 23. On the other hand, when the energization of the coil 60 is turned off, the valve member 50 is engaged with the bottom portion 22 of the injection nozzle 20, so that the injector 10 is valve-closed. Accordingly, the fuel injection from the injector 10 is cut off.

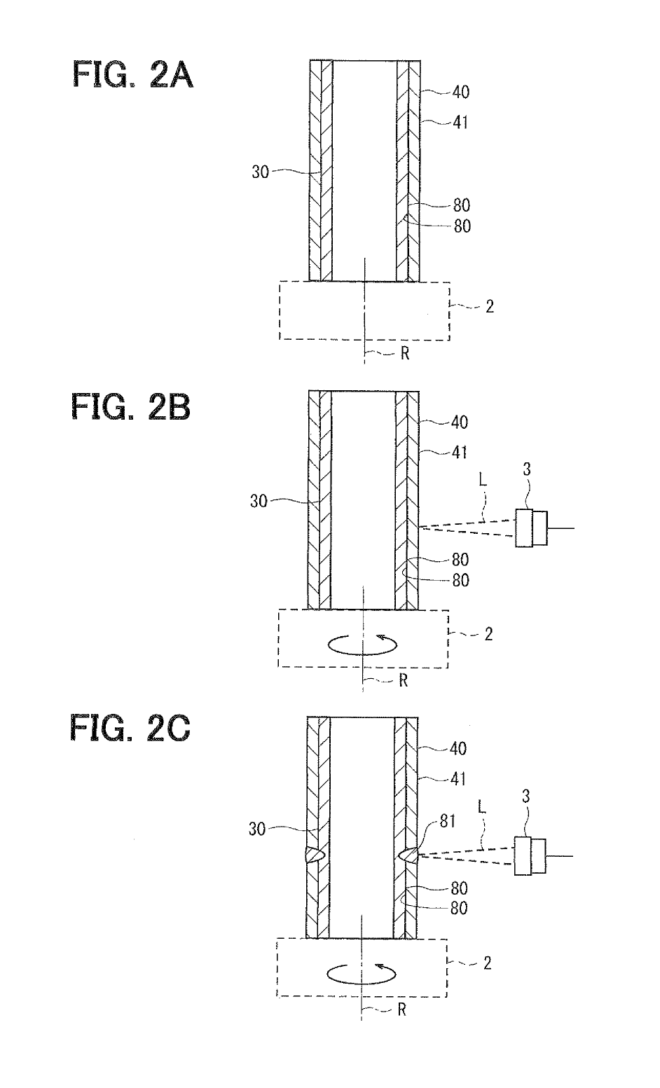

A method for the laser welding between the fuel passage member 30 and the holder 40 in the injector 10 of the present embodiment will be described below with reference to FIGS. 2A to 4. A schematic cross section of the fuel passage member 30 and the first cylindrical portion 41 of the holder 40 in the injector 10 in the course of its production is illustrated in FIGS. 2A to 2C. Here, the explanation will be given with the fuel passage member 30 corresponding to a “first pipe” and the first cylindrical portion 41 corresponding to a “second pipe”.

The laser welding method in the present embodiment includes a fitting process, a preheating process, and a welding process. The fitting process will be described. As illustrated in FIG. 2A, in the fitting process, the fuel passage member 30 and the first cylindrical portion 41 are fitted together such that the outer wall of the fuel passage member 30 and the inner wall of the first cylindrical portion 41 are opposed to each other. Then, the fuel passage member 30 and the first cylindrical portion 41, which are in a fitted state, are disposed on a rotatable table 2, such that the central axis of the fuel passage member 30 and the first cylindrical portion 41 coincides with a rotation axis R of the rotatable table 2. In the present embodiment, the fuel passage member 30 and the first cylindrical portion 41 in a fitted state are disposed in the air under atmospheric pressure.

The preheating process will be described. As illustrated in FIG. 2B, in the preheating process, the fuel passage member 30 and the first cylindrical portion 41 are rotated around the central axis by rotating the rotatable table 2 at a predetermined speed; and an outer wall of the first cylindrical portion 41 is irradiated with a laser light L from a laser irradiation device 3. As a result, heat is generated at a place of the first cylindrical portion 41 that is irradiated with the laser light L, and this heat is transmitted to the fuel passage member 30.

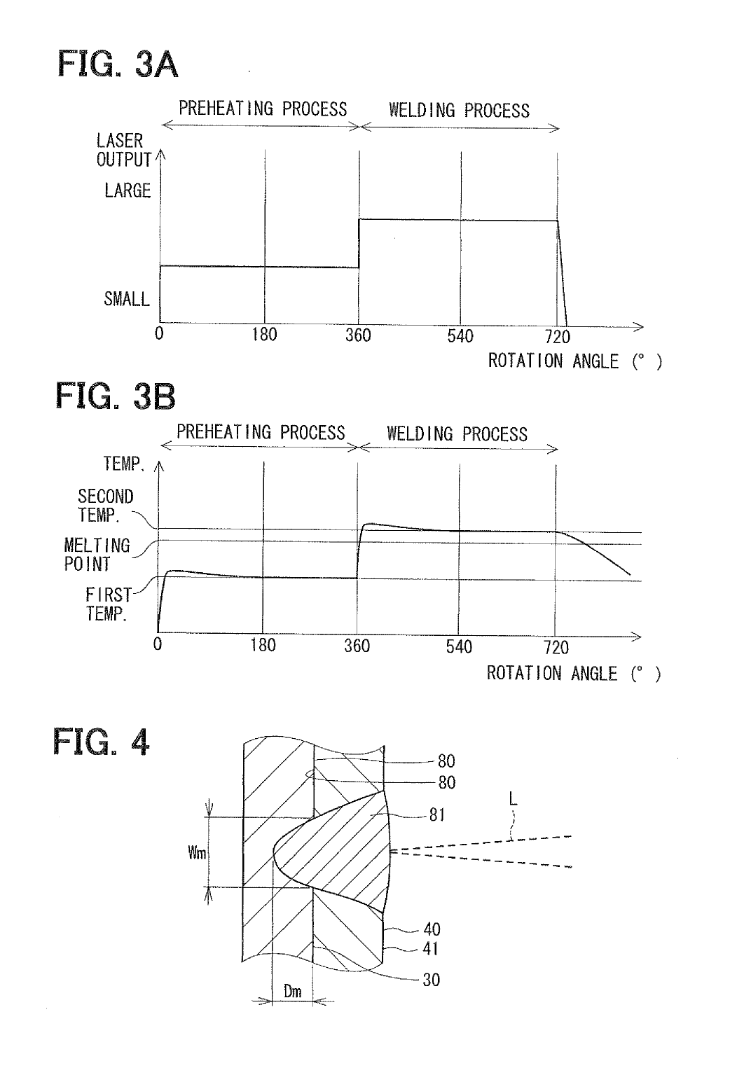

An output value of the laser light L from the laser irradiation device 3 in the above-described case is illustrated on a left-hand side of FIG. 3A. Provided that a rotation angle of the rotatable table 2 (i.e., the fuel passage member 30 and the first cylindrical portion 41) at the time of the start of laser irradiation is 0 (zero) degrees, the laser irradiation device 3 is controlled such that the output value of the laser light L is constant from 0 to 360 degrees, i.e., while the rotatable table 2 rotates once. Accordingly, temperature of the fitting surface 80 between the outer wall of the fuel passage member 30 and the inner wall of the first cylindrical portion 41 changes as illustrated on a left-hand side of FIG. 3B. Although the temperature of the fitting surface 80 becomes higher than a first temperature immediately after the start of laser irradiation, the temperature of the fitting surface 80 converges at the first temperature in a short time. Here, the first temperature is a predetermined temperature that is lower than melting points of the fuel passage member 30 and the first cylindrical portion 41.

In this manner, in the preheating process, by the irradiation of the outer wall of the first cylindrical portion 41 with the laser, the member 30 and the portion 41 are heated (preheated) such that the temperature of the fitting surface 80 converges at the first temperature. A period after the laser irradiation is started until the rotatable table 2 rotates once corresponds to the preheating process.

The welding process will be described. In the present embodiment, the welding process is started immediately after the preheating process. As illustrated on a right-hand side of FIG. 3A, the output value of the laser light L is increased immediately after the preheating process, i.e., when the rotatable table 2 rotates once. The laser irradiation device 3 is controlled such that the output value of the laser light L is constant from this point until the rotatable table 2 rotates once. As a result, the temperature of the fitting surface 80 varies as illustrated on a right-hand side of FIG. 3B. Although the temperature of the fitting surface 80 becomes higher than a second temperature immediately after the start of the welding process, the temperature of the fitting surface 80 soon converges at the second temperature. Here, the second temperature is a predetermined temperature that is equal to or higher than the melting points of the fuel passage member 30 and the first cylindrical portion 41.

As illustrated in FIGS. 2C and 4, in the welding process, the first cylindrical portion 41 and the fuel passage member 30 are melted because of the laser irradiation, and the weld penetration part 81 is produced from the outer wall of the first cylindrical portion 41 toward the vicinity of the fitting surface 80. As a result of the rotation of the rotatable table 2 (i.e., the fuel passage member 30 and the first cylindrical portion 41), the weld penetration part 81 is formed into a generally annular shape. Consequently, the fuel passage member 30 and the first cylindrical portion 41 are welded (joined) together, and the clearance between the outer wall of the fuel passage member 30 and the inner wall of the first cylindrical portion 41 is kept liquid-tight. Here, an object obtained as a result of joining together the fuel passage member 30 and the first cylindrical portion 41 corresponds to a “pipe joint product”.

The second temperature is such a temperature that the front end of the weld penetration part 81 is located within the thickness of the fuel passage member 30. More specifically, in the present embodiment, by adjusting the output value of the laser light L, and an irradiation time of the laser light L, i.e., a rotational speed of the rotatable table 2, a weld penetration depth Dm and a weld penetration width Wm of the weld penetration part 81 are controlled such that the depth Dm and the width Wm take predetermined values. In the present embodiment, immediately before the welding process, the member 30 and the portion 41 are preheated so that the temperature of the fitting surface 80 reaches the first temperature. Accordingly, the temperature of the fitting surface 80 does not rapidly increase in the welding process. Thus, the penetration depth Dm and the penetration width Wm of the weld penetration part 81 are easily controllable. In the present embodiment, thicknesses of the fuel passage member 30 and the first cylindrical portion 41 are approximately 0.35 mm, and an outer diameter of the fuel passage member 30 is approximately 6 mm. In addition, the rotational speed of the rotatable table 2 is about 200 to 400 rpm.

In the “pipe joint product” (i.e., the fuel passage member 30 and the first cylindrical portion 41) formed through the above-described welding process, the front end of the weld penetration part 81 is located within the thickness of the fuel passage member 30. Therefore, the inner wall of the fuel passage member 30 maintains its pre-welding metallic luster, and for example, surface roughness of the inner wall of the member 30 is kept at a high level.

“The inner wall of the fuel passage member 30 maintaining its pre-welding metallic luster” means that there is no discoloration of the inner wall due to “burn” or oxidation. More specifically, by the laser welding method of the invention, the weld penetration depth can be accurately controlled so that the front end of the weld penetration part 81 is located within the thickness of the fuel passage member 30. Accordingly, the inner wall of the fuel passage member 30 is not burned or oxidized. Thus, through the observation of the inner wall of the fuel passage member 30, determination of the pipe joint product formed by the laser welding method of the invention can be made.

In the present embodiment, the injection nozzle 20 and the fuel passage member 30 are also joined (welded) together by the above-described laser welding method. In this case, the cylindrical portion 21 of the injection nozzle 20 may correspond to the “first pipe”, and the fuel passage member 30 may correspond to the “second pipe”. By welding the nozzle 20 and the member 30 together using this method, a front end of the weld penetration part 71, which is produced as a result of the melting of vicinity of the fitting surface 70 between the outer wall of the cylindrical portion 21 and the inner wall of the fuel passage member 30, is located within thickness of the cylindrical portion 21. As a result, an inner wall of the cylindrical portion 21 maintains its pre-welding metallic luster.

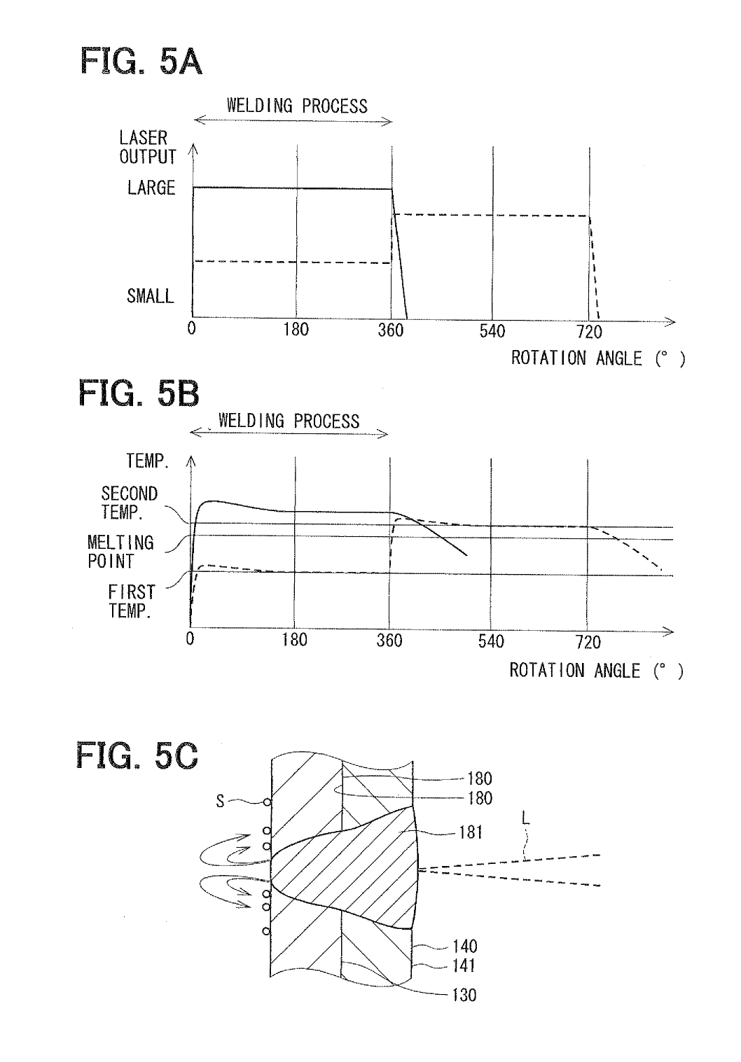

A laser welding method in accordance with a comparative example will be described in reference to FIGS. 5A to 5C. Unlike the laser welding method of the above-described present embodiment, the comparative example is a laser welding method without performing the “preheating process”. Therefore, the comparative example is similar to the conventional laser welding method.

In the comparative example, after a fitting process, a welding process is started without going through the above preheating process. Meanwhile, as indicated by a continuous line on a left-hand side of FIG. 5A, an output value of a laser light L is maintained constant at a value that is larger than the output value of the laser light L (short-dashes line indicated on a right-hand side of FIG. 5A) in the welding process of the present embodiment. Accordingly, temperature of a fitting surface 180 between an outer wall of a fuel passage member 130 and an inner wall of a first cylindrical portion 141 rapidly becomes a temperature that is equal to or higher than a second temperature, as indicated by a continuous line on a left-hand side of FIG. 5B. Due to this rapid rise of temperature, a front end of a weld penetration part 181 reaches an inner wall of the fuel passage member 130, so that sputters S are adhered on this inner wall (see FIG. 5C).

As above, by the laser welding method of the comparative example, the preheating process is not carried out. Thus, the temperature of the fitting surface 180 rises rapidly in the welding process. Consequently, it is difficult to accurately control a position of the front end of the weld penetration part 181, i.e., weld penetration depth and weld penetration width, for example. Accordingly, “penetration” or “adhesion of sputter” because of welding may be caused. Furthermore, the output value of the laser light L that is required in the welding process of the comparative example is larger than the output value needed in the welding process of the present embodiment.

As described above, the method for laser welding between the fuel passage member 30 and the holder 40 in the injector 10 of the present embodiment includes the fitting process, the preheating process, and the welding process. In the fitting process, the fuel passage member 30 and the first cylindrical portion 41 are fitted together such that the outer wall of the metal fuel passage member 30 (first pipe) and the inner wall of the first cylindrical portion 41 (second pipe) of the metal holder 40 are opposed to each other. In the preheating process, the member 30 and the portion 41 are heated such that the temperature of the fitting surface 80 between the fuel passage member 30 and the first cylindrical portion 41 converges at the first temperature that is lower than melting points of the fuel passage member 30 and the holder 40. In the welding process, the first cylindrical portion 41 is irradiated with the laser to heat the portion 41 so that the temperature of the fitting surface 80 converges at the second temperature, which is equal to or higher than the melting point. By melting the vicinity of the fitting surface 80 through this heating, the fuel passage member 30 and the first cylindrical portion 41 are joined together to form the “pipe joint product”. In the present embodiment, in the welding process, the output value and the irradiation time of the laser light L are set so that the second temperature becomes such a temperature that the front end of the weld penetration part 81, which is generated as a result of the melting of the vicinity of the fitting surface 80, is located within the thickness of the fuel passage member 30.

In this manner, in the present embodiment, in the preheating process, the member 30 and the portion 41 are heated beforehand so that the temperature of the fitting surface 80 reaches nearly the first temperature. Accordingly, at the time of heating by the laser irradiation in the welding process, a sudden temperature rise of the fitting surface 80 can be avoided. Thus, in the welding process, setting of the output value and the irradiation time of the laser light L such that the temperature of the fitting surface 80 reaches generally the second temperature is facilitated. As a result, the weld penetration depth (Dm) can be accurately controlled so that the front end of the weld penetration part 81 is located within the thickness of the fuel passage member 30. Therefore, a penetration defect or generation of sputters is prevented, so that the welding quality of the “pipe joint product” can be improved.

In the present embodiment, by preheating the fitting surface 80 in the preheating process, the output value of the laser light L required at the time of welding in the welding process can be reduced compared to the case in which the fitting surface 80 is not preheated. Moreover, in the welding process, by welding together the fuel passage member 30 and the first cylindrical portion 41 with the member 30 and the portion 41, which are in a fitted state, rotated around their central axis, uniform welding along their whole circumference is achieved.

In the present embodiment, in the preheating process, through the irradiation of the first cylindrical portion 41 with the laser, the member 30 and the portion 41 are heated such that the temperature of the fitting surface 80 converges at the first temperature. Accordingly, in the present embodiment, preheating of the fitting surface 80 in the preheating process and heating of the fitting surface 80 in the welding process can be performed continuously in a series of processes by a single laser irradiation device 3. In the present embodiment, by heating the member 30 and the portion 41 through the laser irradiation, the temperature of the fitting surface 80 can be made to reach nearly the first temperature in a comparatively short time. Consequently, a period of the preheating process can be shortened.

In the present embodiment, in the preheating process, the portion 41 is irradiated with the laser at a constant output from commencement to termination of the laser irradiation. In the present embodiment, by the laser irradiation with the member 30 and the portion 41 in a fitted state rotated around their central axis, the member 30 and the portion 41 can be preheated so that the temperature of the fitting surface 80 reaches generally the first temperature along its whole circumference.

In the “pipe joint product” formed by the laser welding method in accordance with the present embodiment, the inner wall of the fuel passage member 30 maintains its pre-welding metallic luster. Thus, determination of the “pipe joint product” that is formed by this laser welding method can be made through observation of the inner wall of the fuel passage member 30.

In order that the fuel passage member 30 reduces flow resistance of high-pressure fuel, and that the fuel passage member 30 prevents incorporation of foreign substances exfoliated from its inner wall into fuel due to a flow of high-pressure fuel, a high level of quality is required for, for example, surface roughness of the inner wall of the fuel passage member 30. For this reason, if the above-described laser welding method is applied as a welding method for the fuel passage member 30 of the injector 10, a particularly great effect is obtained.

In addition, in the present embodiment, the above-described laser welding method is applied also to welding between the injection nozzle 20 and the fuel passage member 30. In this case, the injection nozzle 20 may correspond to the “first pipe”, and the fuel passage member 30 may correspond to the “second pipe”. In such a case as well, an effect similar to the above-described effect is produced.

### Second Embodiment

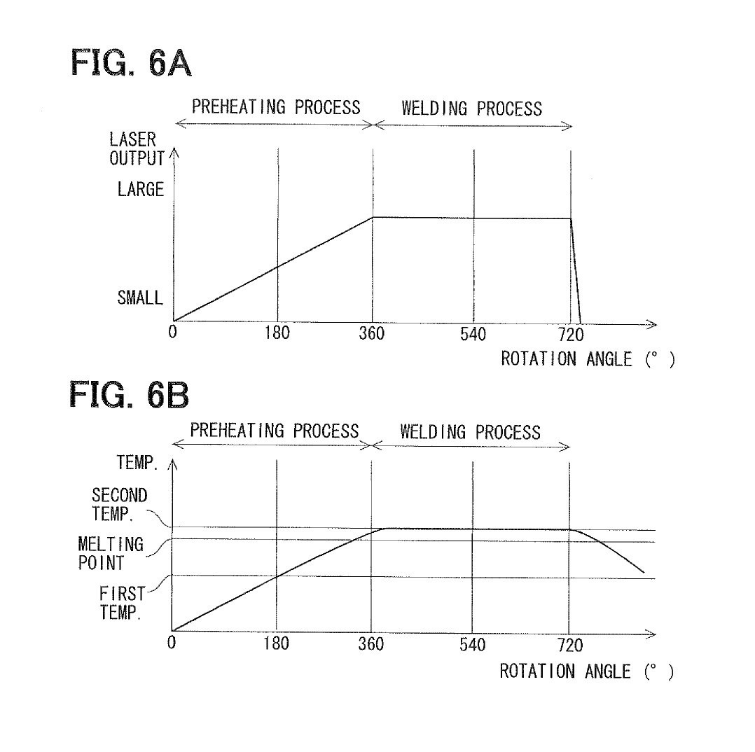

An injector in accordance with a second embodiment of the invention will be described with reference to FIGS. 6A and 6B. While the second embodiment is similar to the first embodiment with regard to configuration of the injector, part (preheating process) of a laser welding method is different from the first embodiment.

In the second embodiment, as illustrated on a left-hand side of FIG. 6A, in a preheating process, a laser irradiation device 3 is controlled such that an output value of a laser light L gradually becomes high, from 0 degrees to 360 degrees of a rotation angle of a rotatable table 2 (i.e., a fuel passage member 30 and a first cylindrical portion 41), i.e., while the rotatable table 2 rotates once. Accordingly, temperature of a fitting surface 80 between an outer wall of the fuel passage member 30 and an inner wall of the first cylindrical portion 41 changes as illustrated on a left-hand side of FIG. 6B. Here, a continuous line indicated on the left-hand side of FIG. 6B expresses a temperature at each place of the fitting surface 80 in its circumferential direction (i.e., each rotation angle). Actually, the fuel passage member 30 and the first cylindrical portion 41 are preheated, being rotated. Thus, an average value of the temperature of the fitting surface 80 converges at nearly a first temperature in the preheating process. After the preheating process, a welding process is performed similar to the first embodiment, and the fuel passage member 30 and a holder 40 are welded (joined) together.

As described above, in the present embodiment, in the preheating process, the portion 41 is irradiated with the laser with the output of the laser gradually increased from commencement to termination of laser irradiation. In the present embodiment, for example, by irradiating the fuel passage member 30 and the first cylindrical portion 41 with the laser, with the member 30 and the portion 41 that are in a fitted state rotated around their central axis at a relatively high speed, the member 30 and the portion 41 can be preheated so that the temperature of the fitting surface 80 reaches generally the first temperature along its whole circumference. The present embodiment is suitable when diameters and thicknesses of the fuel passage member 30 and the first cylindrical portion 41 are comparatively small; and a rotational speed of the table 2 at the time of preheating is comparatively high.

### Third Embodiment

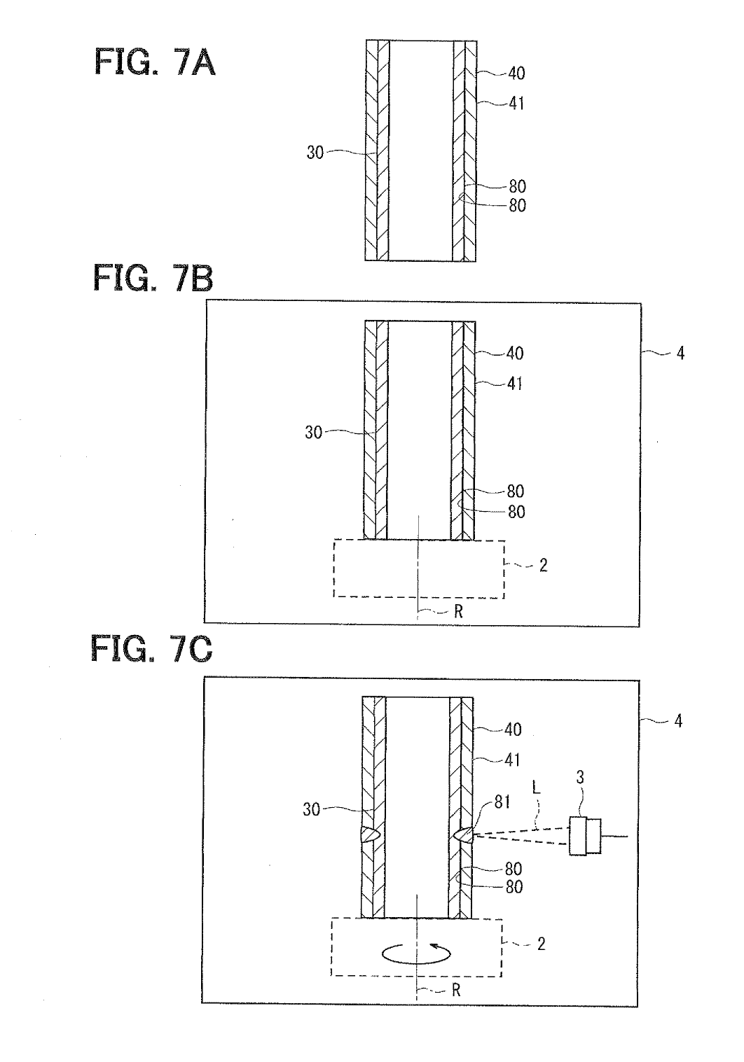

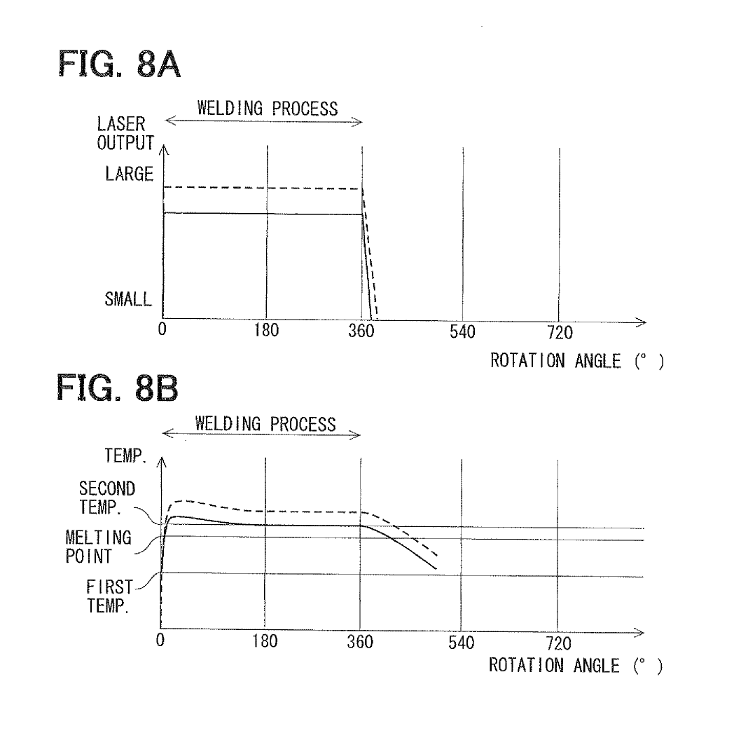

An injector in accordance with a third embodiment of the invention will be described in reference to FIGS. 7A to 8B. While the third embodiment is similar to the first and second embodiments with regard to configuration of the injector, part (preheating process) of a laser welding method is different from the first and second embodiments.

The third embodiment is different from the first and second embodiments in preheating of a fuel passage member 30 and a holder 40 without using a laser in a preheating process. A method for the laser welding between the fuel passage member 30 and the holder 40 in the injector of the third embodiment will be described below.

A fitting process will be described. As illustrated in FIG. 7A, in the fitting process, the fuel passage member 30 and a first cylindrical portion 41 are fitted together such that an outer wall of the fuel passage member 30 and an inner wall of the first cylindrical portion 41 are opposed to each other. A preheating process will be described. As illustrated in FIG. 7B, in the preheating process, the fuel passage member 30 and the first cylindrical portion 41, which are in a fitted state, are disposed on a rotatable table 2 inside a heating chamber 4. The fuel passage member 30 and the first cylindrical portion 41 are disposed on the rotatable table 2, such that the central axis of the member 30 and the portion 41 coincides with a rotation axis R of the table 2. Then, by heating gas in the heating chamber 4 (air in the present embodiment), the fuel passage member 30 and the holder 40 are heated (preheated) such that temperature of a fitting surface 80 converges at a first temperature. Here, the first temperature is a predetermined temperature that is lower than melting points of the fuel passage member 30 and the first cylindrical portion 41.

A welding process will be described. In the welding process, the fuel passage member 30 and the first cylindrical portion 41 are rotated around the central axis by rotating the rotatable table 2 at a predetermined speed; and an outer wall of the first cylindrical portion 41 is irradiated with a laser light L from a laser irradiation device 3. An output value of the laser light L is constant as indicated by a continuous line in FIG. 8A from 0 degrees to 360 degrees of a rotation angle of the rotatable table 2 (i.e., the fuel passage member 30 and the first cylindrical portion 41), i.e., while the table 2 rotates once. Accordingly, the temperature of the fitting surface 80 changes as indicated by a continuous line in FIG. 8B. Although the temperature of the fitting surface 80 becomes higher than a second temperature immediately after the start of the welding process, the temperature of the fitting surface 80 soon converges at the second temperature. Here, the second temperature is a predetermined temperature that is equal to or higher than the melting points of the fuel passage member 30 and the first cylindrical portion 41.

As illustrated in FIG. 7C, in the welding process, the first cylindrical portion 41 and the fuel passage member 30 are melted because of the laser irradiation, and a weld penetration part 81 is produced from the outer wall of the first cylindrical portion 41 toward the vicinity of the fitting surface 80. As a result of the rotation of the rotatable table 2 (i.e., the fuel passage member 30 and the first cylindrical portion 41), the weld penetration part 81 is formed into a generally annular shape. Consequently, the fuel passage member 30 and the first cylindrical portion 41 are welded (joined) together, and the clearance between the outer wall of the fuel passage member 30 and the inner wall of the first cylindrical portion 41 is kept liquid-tight.

In the present embodiment, immediately before the welding process, the member 30 and the portion 41 are preheated such that the temperature of the fitting surface 80 reaches the first temperature. Accordingly, the temperature of the fitting surface 80 does not rapidly increase in the welding process. Thus, a weld penetration depth and a weld penetration width of the weld penetration part 81 are easily controllable. In the “pipe joint product” (i.e., the fuel passage member 30 and the first cylindrical portion 41) formed through the above-described welding process, a front end of the weld penetration part 81 is located within thickness of the fuel passage member 30. Therefore, the inner wall of the fuel passage member 30 maintains its pre-welding metallic luster, and for example, surface roughness of the inner wall of the member 30 is kept at a high level.

For comparison, the output value of the laser light which is required in the welding process of the above-described comparative example is illustrated in FIG. 8A with a short-dashes line. It turns out from FIG. 8A that, in the present embodiment, the output value of the laser light required in the welding process is lower than the comparative example, in which preheating is not performed. In addition, as indicated by a short-dashes line in FIG. 8B, in the welding process of the comparative example, the temperature of the fitting surface 80 rises rapidly immediately after the start of laser irradiation. On the other hand, as indicated by a continuous line in FIG. 8B, in the welding process of the present embodiment, a sudden temperature rise of the temperature of the fitting surface 80 (temperature rising rate per unit time) immediately after the start of laser irradiation is limited.

As described above, in the present embodiment, in the preheating process, the fuel passage member 30 and the first cylindrical portion 41, which are in a fitted state, are disposed in the heating chamber 4; and by heating the gas in the heating chamber 4, the member 30 and the portion 41 are heated such that the temperature of the fitting surface 80 converges at the first temperature. In the present embodiment, it takes a predetermined time to preheat each pair of the fuel passage member 30 and the first cylindrical portion 41. However, for example, if more than one pair of the fuel passage member 30 and the first cylindrical portion 41 are preheated at one time inside the heating chamber 4, operating efficiency can be improved. In the present embodiment, since a laser is not used for the preheating, electricity supplied to the laser irradiation device 3 can be reduced compared to the method that employs a laser also for the preheating (first and second embodiments).

Modifications of the above embodiments will be described. In a modification of the invention, in the preheating process, as long as temperature of the fitting surface of the “first pipe” and the “second pipe” converges generally at the first temperature, the output of the laser, with which the second pipe is irradiated, and the rotational speed of the rotatable table may be controlled in any manner. In the welding process, as long as the temperature of the fitting surface converges generally at the second temperature, the output of the laser, with which the second pipe is irradiated, and the rotational speed of the rotatable table may be controlled in any manner.

In the above-described embodiment, the example of laser welding in the air under atmospheric pressure in the welding process is described. In a modification of the invention, laser welding may be performed in inert gas, such as nitrogen, argon, or helium, or in low-pressure air. Or, the laser welding may be carried out with the inert gas sprayed over the welded place.

In the above embodiment, the example of irradiation of the outer wall of the “second pipe” with a laser in its circumferential direction by fixing the laser irradiation device and rotating the “first pipe” and the “second pipe” in the preheating process and the welding process is described. In a modification of the invention, the outer wall of the “second pipe” may be irradiated with a laser in its circumferential direction by rotating the laser irradiation device with the “first pipe” and the “second pipe” fixed.

Instead of the embodiment in which the whole circumference of the pipe is evenly welded through the continuous irradiation with a laser light during the relative rotation between the first and second pipes and the laser irradiation device, the pipe may be “spot welded” through intermittent irradiation with a laser light. In this case, although liquid-tightness between the “first pipe” and the “second pipes” decreases, the liquid-tightness can be ensured by providing a sealing member such as an O ring between the “first pipe” and the “second pipes”.

In a modification of the invention, the “pipe joint product” formed by the above-described laser welding method may be used not only for the injector but also as a component of various devices or apparatuses, for example. As above, the invention is not by any means limited to the above embodiments, and may be embodied in various modes without departing from the scope of the invention.

Additional advantages and modifications will readily occur to those skilled in the art. The invention in its broader terms is therefore not limited to the specific details, representative apparatus, and illustrative examples shown and described.

What is claimed is:

1. A laser welding method comprising:
performing a fitting process, wherein the performing of the fitting process includes fitting together a first pipe made of metal and a second pipe made of metal such that an outer wall of the first pipe and an inner wall of the second pipe are opposed to each other;
performing a preheating process, wherein the performing of the preheating process includes heating the first pipe and the second pipe such that temperature of a fitting surface between the first pipe and the second pipe converges at a first temperature, which is lower than melting points of the first pipe and the second pipe; and
performing a welding process, wherein the performing of the welding process includes:
irradiating the second pipe with a laser to heat the first pipe and the second pipe such that the temperature of the fitting surface converges at a second temperature, which is equal to or higher than the melting points;
melting a vicinity of the fitting surface to produce a weld penetration part; and
joining together the first pipe and the second pipe to form a pipe joint product, wherein an output and an irradiation time of the laser in the welding process are set, so that the second temperature becomes such a temperature that a leading end of the weld penetration part is located within thickness of the first pipe.

2. The laser welding method according to claim 1, wherein the performing of the preheating process further includes irradiating the second pipe with the laser to heat the first pipe and the second pipe such that the temperature of the fitting surface converges at the first temperature.

3. The laser welding method according to claim 2, wherein the performing of the preheating process further includes irradiating the second pipe with the laser at a constant output thereof from commencement to termination of the irradiating of the second pipe with the laser.

4. The laser welding method according to claim 2, wherein the performing of the preheating process further includes irradiating the second pipe with the laser, with the output of the laser gradually increased from commencement to termination of the irradiating of the second pipe with the laser.

5. The laser welding method according to claim 1, wherein the performing of the preheating process further includes:
disposing the first pipe and the second pipe, which are in a fitted state, in a heating chamber; and
heating the first pipe and the second pipe such that the temperature of the fitting surface converges at the first temperature by heating gas in the heating chamber.

6. A pipe joint product formed by the laser welding method according to claim 1, wherein an inner wall of the first pipe maintains its pre-welding metallic luster.

7. An injector adapted for a fuel injection system of an internal combustion engine, the injector comprising:
an injection nozzle that has a nozzle hole through which fuel is injected;
a fuel passage member that is joined to the injection nozzle and defines a fuel passage communicating with the nozzle hole;
a holder that is joined to the fuel passage member on its opposite side from the injection nozzle;
a valve member that is accommodated inside the fuel passage member to reciprocate therein so as to open or close the nozzle hole; and
a driving unit that is accommodated in the holder and configured to drive the valve member, wherein the fuel passage member and the holder correspond respectively to the first pipe and the second pipe of the pipe joint product recited in claim 6.
